(19) United States
(12) Patent Application Publication
(10) Pub. No.: US 2026/0072244 A1
(43) Pub. Date: Mar. 12, 2026

(54) OPTICAL SYSTEM, DISPLAY APPARATUS, AND IMAGE PICKUP APPARATUS

(71) Applicant: CANON KABUSHIKI KAISHA, Tokyo (JP)

(72) Inventors: Tomohiro INO, Tochigi (JP); Takaho MATSUDA, Tochigi (JP)

(21) Appl. No.: 19/276,512

(22) Filed: Jul. 22, 2025

(30) Foreign Application Priority Data
Sep. 12, 2024 (JP) 2024-157960

(51) Int. Cl. G02B 9/34; G02B 9/36; G02B 27/01; G03B 13/06

(52) U.S. Cl. CPC G02B 9/34; G02B 9/36; G02B 27/0172; G03B 13/06

(57) ABSTRACT

Optical systems, display apparatuses, and image pickup apparatuses are provided herein. One or more optical systems configured to guide light from a display element to an observation side, may include a plurality of lenses that consist of, in order from a display element side to the observation side, a first lens with positive refractive power, a second lens with negative refractive power, a third lens with refractive power, and a fourth lens with refractive power. A predetermined inequality is satisfied.

### BACKGROUND

### Field of the Technology

The disclosure relates to one or more embodiments of an optical system for a display apparatus, such as an electronic viewfinder.

### Description of the Related Art

Electronic viewfinders for image pickup apparatuses such as video cameras and broadcasting cameras use an optical system that enlarges and displays an image on a display element. Such optical systems are demanded to have a sufficiently large field (i.e., high magnification), a long eye relief, and good correction ability of a variety of aberrations.

### SUMMARY

One or more embodiments of an optical system according to one or more aspects of the disclosure configured to guide light from a display element to an observation side, the optical system may include a plurality of lenses that consist of, in order from a display element side to the observation side, a first lens with positive refractive power, a second lens with negative refractive power, a third lens with refractive power, and a fourth lens with refractive power. The following inequalities are satisfied:

$$- 10.00 < f 4 / f 3 < 0 \text{.15}$$

$$- 5. < ( R 41 + R 42 ) / ( R 41 - R 42 ) < - 0.19$$

$$0.5 < LD / L 1 < 40.0$$

where f3 is a focal length of the third lens, f4 is a focal length of the fourth lens, R41 is a radius of curvature of a display-element-side surface of the fourth lens, R42 is a radius of curvature of an observation-side surface of the fourth lens, L1 is an air-equivalent distance from a display surface of the display element to a display-element-side surface of the first lens in a case where diopter is −1 diopter, and LD is a distance on an optical axis from the display-element-side surface of the first lens to the observation-side surface of the fourth lens. Alternatively, the following inequality is satisfied:

$$0 \text{.5} < LD / L 1 < 40.0$$

where L1 is an air-equivalent distance from a display surface of the display element to a display-element-side surface of the first lens in a case where diopter is −1 diopter, and LD is a distance on an optical axis from the display-element-side surface of the first lens to an observation-side surface of the fourth lens. One or more display apparatuses and image pickup apparatuses may include one or more optical systems in accordance with one or more other aspects of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of a display optical system according to Example 1.

FIG. 2 is an aberration diagram of the display optical system according to Example 1.

FIG. 3 is a sectional view of a display optical system according to Example 2.

FIG. 4 is an aberration diagram of the display optical system according to Example 2.

FIG. 5 is a sectional view of a display optical system according to Example 3.

FIG. 6 is an aberration diagram of the display optical system according to Example 3.

FIG. 7 is a sectional view of a display optical system according to Example 4.

FIG. 8 is an aberration diagram of the display optical system according to Example 4.

FIG. 9 is a sectional view of a display optical system according to Example 5.

FIG. 10 is an aberration diagram of the display optical system according to Example 5.

FIG. 11 is a sectional view of a display optical system according to Example 6.

FIG. 12 is an aberration diagram of the display optical system according to Example 6.

FIG. 13 is a sectional view of a display optical system according to Example 7.

FIG. 14 is an aberration diagram of the display optical system according to Example 7.

FIG. 15 is a sectional view of a display optical system according to Example 8.

FIG. 16 is an aberration diagram of the display optical system according to Example 8.

FIG. 17 is a sectional view of a display optical system according to Example 9.

FIG. 18 is an aberration diagram of the display optical system according to Example 9.

FIG. 19 is a sectional view of a display optical system according to Example 10.

FIG. 20 is an aberration diagram of the display optical system according to Example 10.

FIG. 21 illustrates an image pickup apparatus having the display optical system according to any one of Examples 1 to 10.

FIG. 22 illustrates a head mounted display (HMD) using the display optical system according to any one of Examples 1 to 10.

### DESCRIPTION OF THE EMBODIMENTS

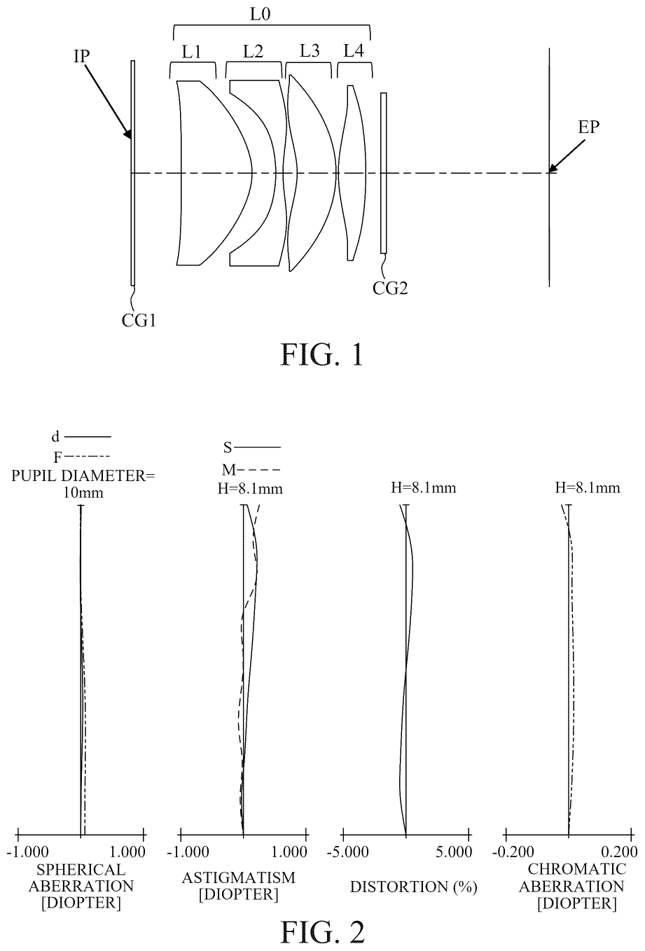

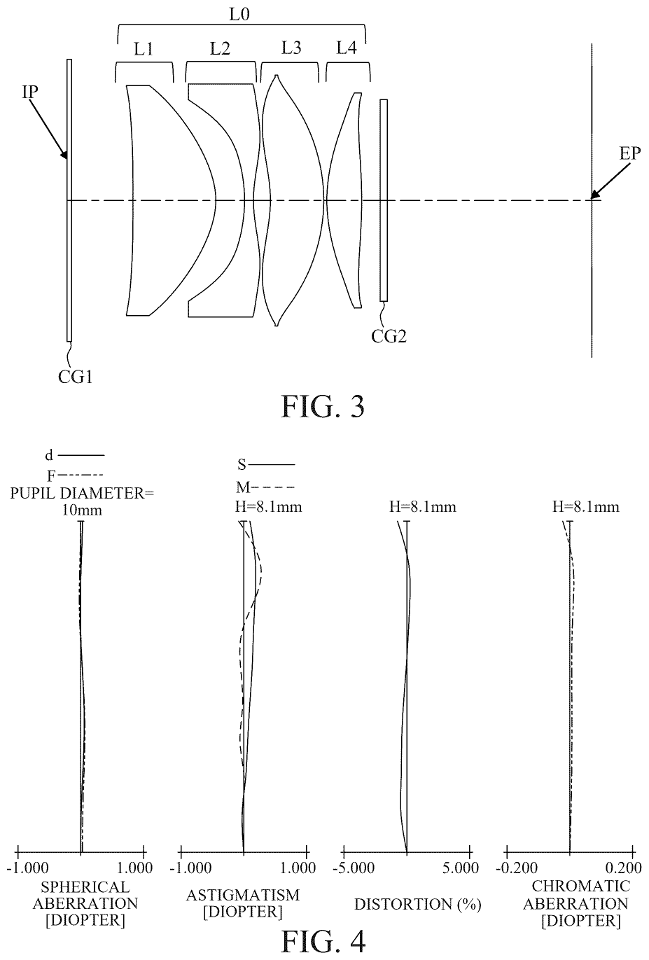

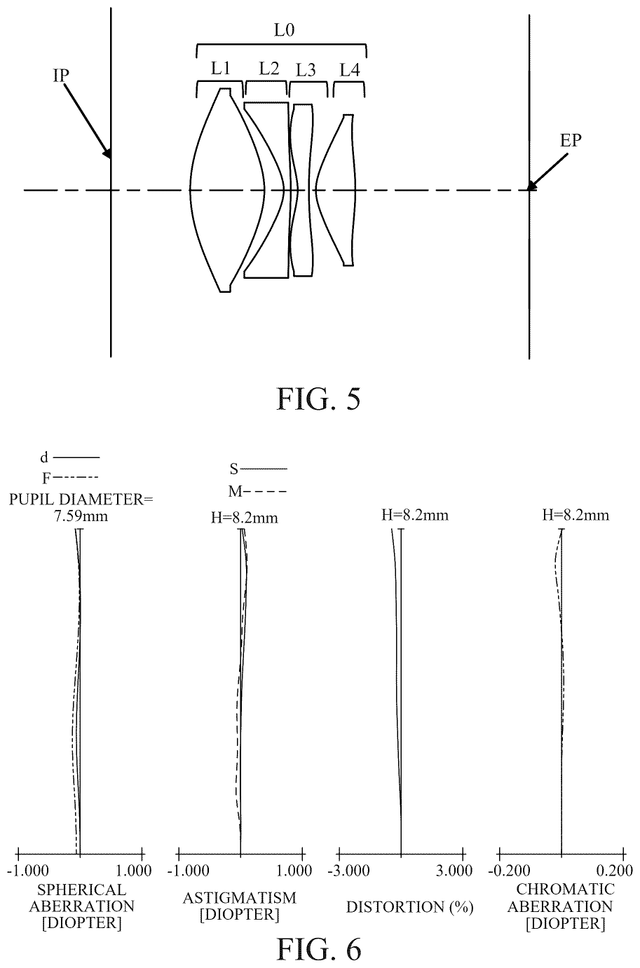

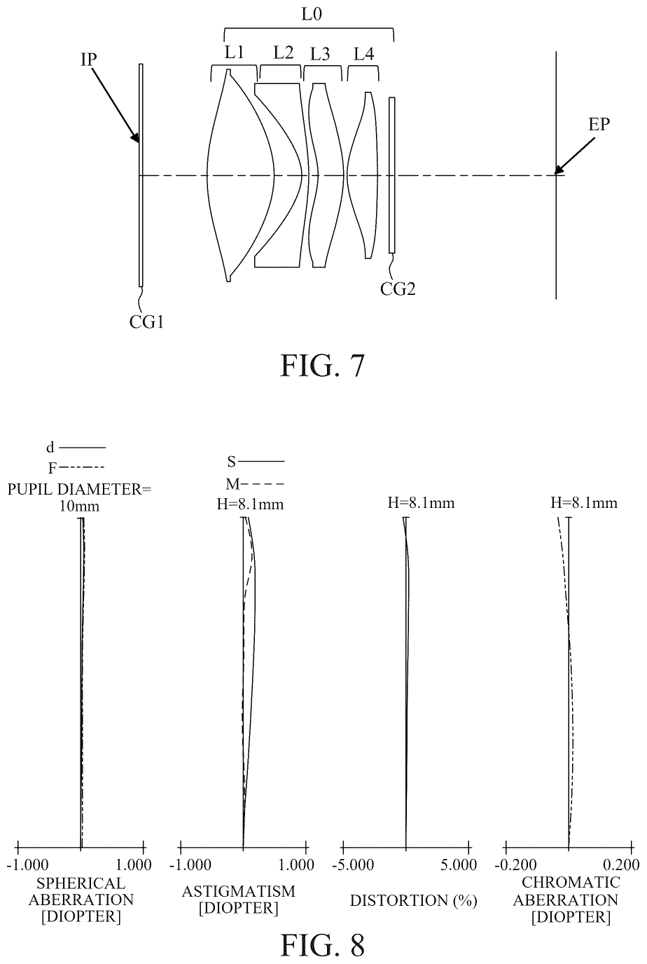

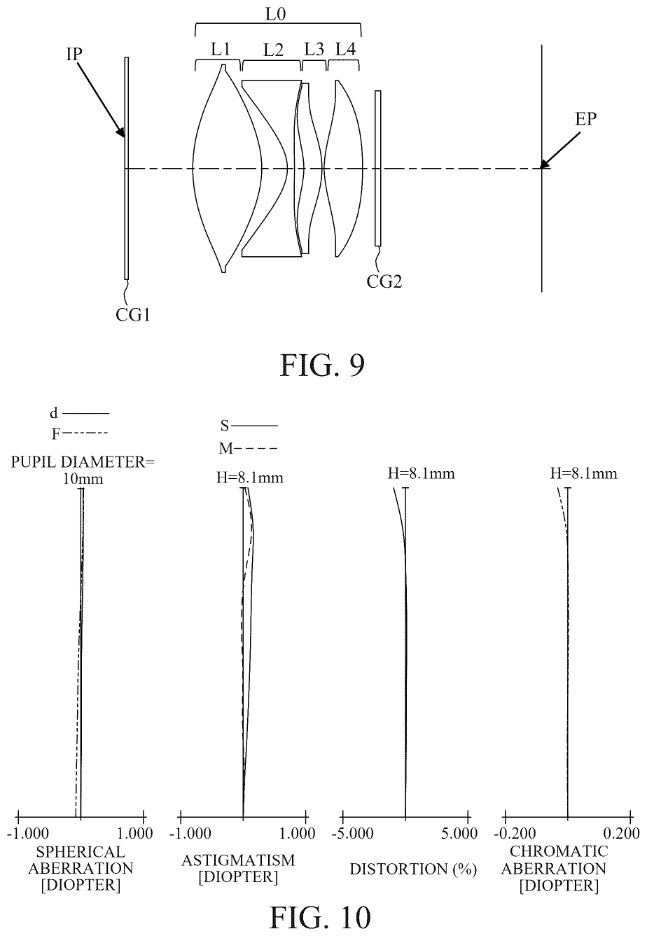

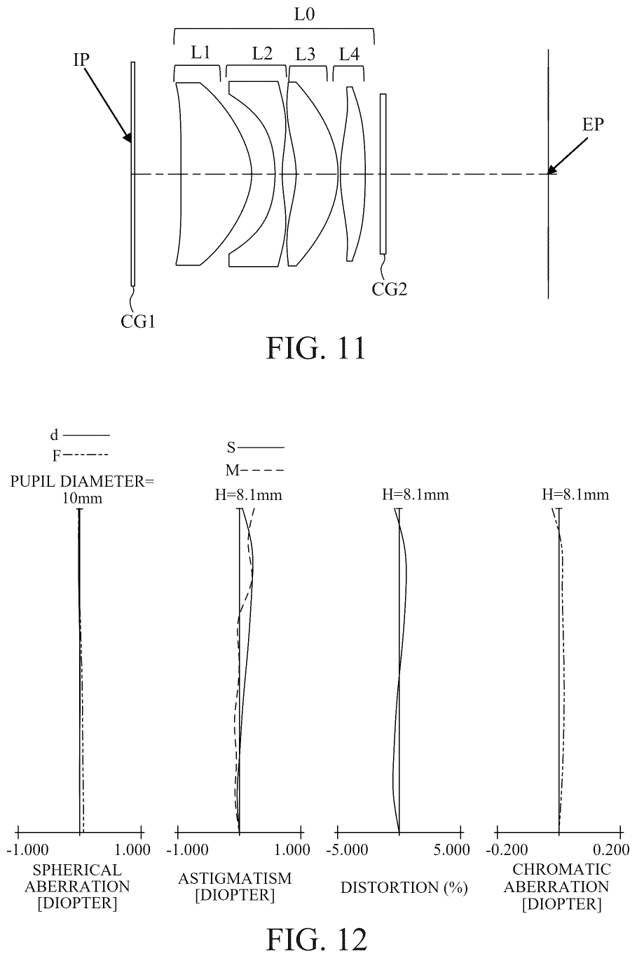

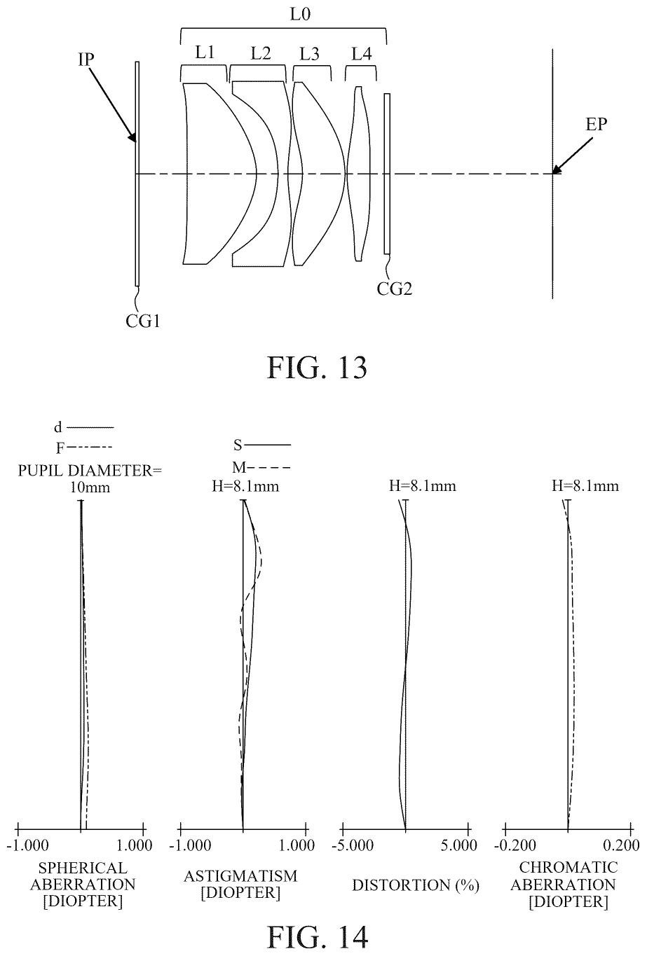

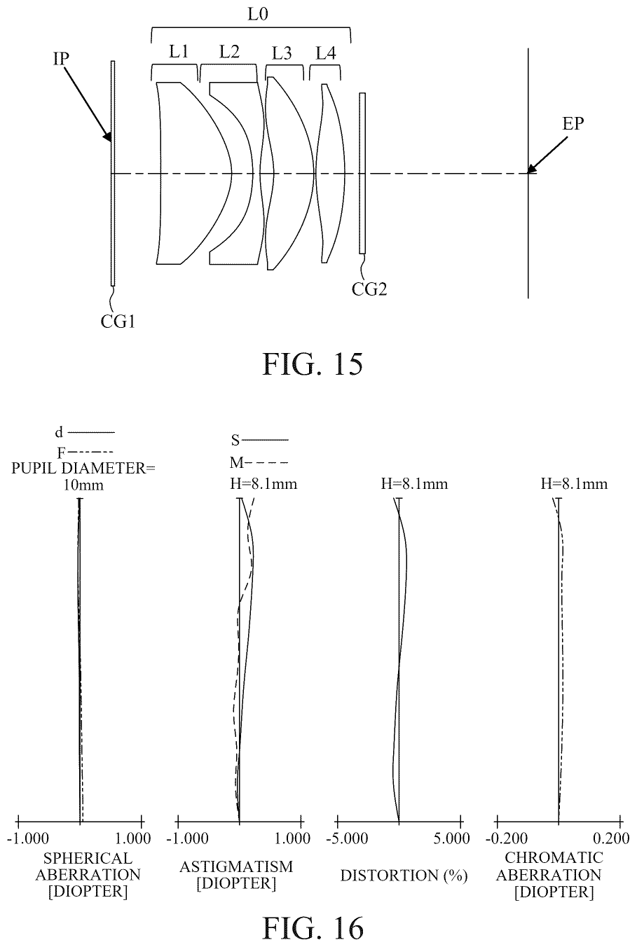

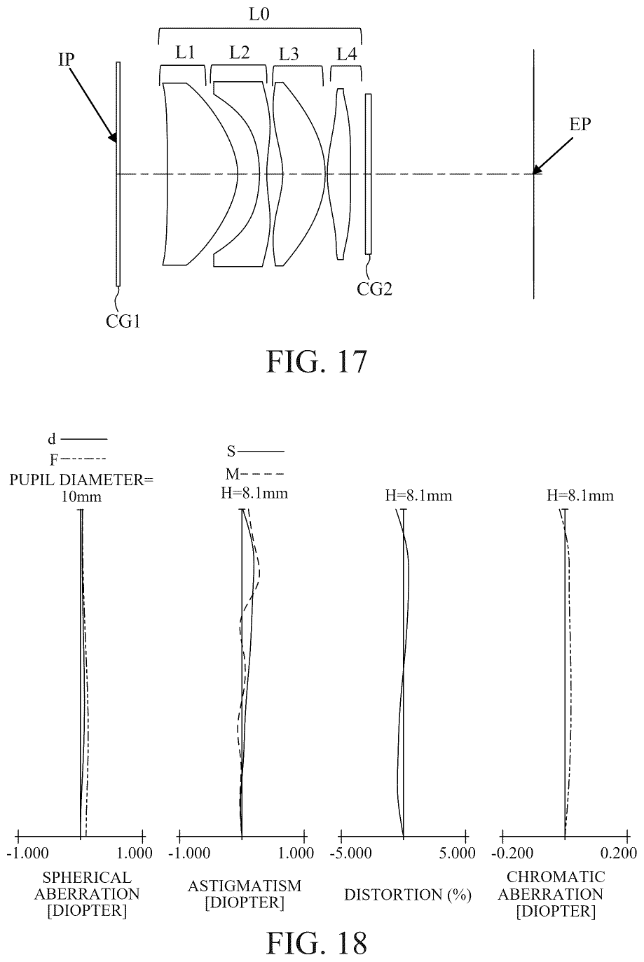

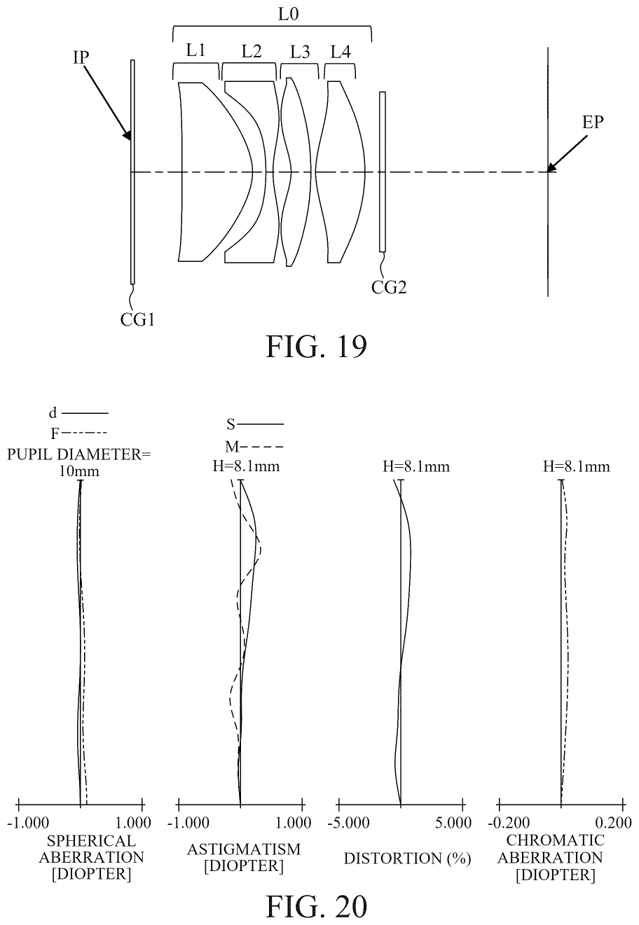

Referring now to the accompanying drawings, a description will be given of embodiments according to the disclosure. Display optical systems L0 according to Examples 1 to 10 illustrated in FIGS. 1, 3, 5, 7, 9, 11, 13, 15, 17, and 19 are used for electronic viewfinders as display apparatuses in image pickup apparatuses such as video cameras, still cameras, and broadcasting cameras. The display optical system L0 may be used for a head-mounted display (HMD) as a display apparatus.

In each figure, a left side is a display element side, and a right side is an observation side (exit pupil side). The display optical system L0 according to each example guides light from the display element to the observation side. The display element includes a liquid crystal element, an organic EL element, etc., and displays an image (original image) on its display surface IP. Thereby, an observer with his eye positioned at an observation surface (eye point) EP set at the position of the exit pupil can observe an enlarged image of the original image.

In order to enable enlarged observation at a sufficiently large angle of field (e.g., 30° or more) using a small display element (e.g., a diagonal length of the display surface is 20 mm or less), each lens constituting the display optical system may have strong positive or negative refractive power, and the entire display optical system may have strong positive refractive power. However, in such a display optical system, spherical aberration, curvature of field, astigmatism, and chromatic aberration occur significantly, and it becomes difficult to obtain high optical performance by satisfactorily correcting these aberrations.

Therefore, the display optical system L0 according to each example includes (consists of), in order from the display element side to the observation side, a first lens L1 with positive refractive power, a second lens L2 with negative refractive power, a third lens L3 with positive or negative refractive power, and a fourth lens L4 with positive or negative refractive power. More specifically, the display optical systems L0 according to Examples 1 to 5 and 8 to 10 include a first lens L1 with positive refractive power, a second lens L2 with negative refractive power, a third lens L3 with negative refractive power, and a fourth lens L4 with positive refractive power. The third lens L3 as a negative lens can correct the Petzval sum of the display optical system L0, and satisfactorily correct curvature of field. The display optical systems L0 according to Examples 6 and 7 include a first lens L1 with positive refractive power, a second lens L2 with negative refractive power, a third lens L3 with positive refractive power, and a fourth lens L4 with positive refractive power. The third lens L3 as a positive lens can increase the positive refractive power on the observation side to achieve high magnification. In a case where the third lens L3 is a positive lens, the fourth lens L4 may be a negative lens.

In Examples 1 and 2 and 4 to 10, a first cover glass CG1 configured to cover the display surface IP of the display element and a second cover glass CG2 configured to cover an image-side surface of the fourth lens L4 are provided. These first and second cover glasses CG1 and CG2 are both parallel flat plates that have no refractive power and are not included as components of the display optical systems L0.

In the above configuration, f3 is a focal length of the third lens L31 f4 is a focal length of the fourth lens L4, R41 is a radius of curvature of a display-element-side surface of the fourth lens L4, and R42 is a radius of curvature of an observation-side surface of the fourth lens L4. In a case where the diopter is −1 diopter (D), L1 is an air-equivalent distance from the display surface IP of the display element to a display-element-side surface of the first lens L1, and LD is a distance on the optical axis from the display-element-side surface of the first lens L1 to the observation-side surface of the fourth lens L4. Then, the display optical system L0 according to each example may satisfy at least one of the following inequalities:

$$- 10.00 < f 4 / f 3 < 0 \text{.15} \qquad ( 1 )$$

$$- 5. < ( R 41 + R 42 ) / ( R 41 - R 42 ) < - 0.19 \qquad ( 2 )$$

$$0.5 < LD / L 1 < 40.0 \qquad ( 3 )$$

Inequality (1) defines a proper relationship between the focal length f3 of the third lens L3 and the focal length f4 of the fourth lens L4. If f4/f3 becomes higher than the upper limit of inequality (1), the focal length of the third lens L3 is reduced, i.e., the positive refractive power of the third lens L3 increases, and the rear principal point of the display optical system L0 separates from the observation position. As a result, it becomes difficult to increase the eye relief. In a case where f4/f3 becomes lower than the lower limit of inequality (1), the negative refractive power of the third lens L3 increases, and the front principal point of the display optical system L0 separates from the display surface IP. As a result, the focal length of the display optical system L0 increases, and it becomes difficult to achieve high magnification.

The lower limit of inequality (1) may be set to −5.00, −3.00, or −1.00. The upper limit of inequality (1) may be set to 0.145, 0.143, or 0.141.

Inequality (2) defines a proper shape of the fourth lens L4 (the shape factor represented by the radius of curvature R41 on the display element side and the radius of curvature R42 on the observation side). In a case where the shape factor of the fourth lens L4 becomes higher than the upper limit of inequality (2), the positive refractive power of the observation-side surface of the fourth lens L4 increases, and the positive refractive power of the display-element-side surface of the fourth lens L4 is reduced. As a result, the heights of the outermost light ray at the second lens L2 and the third lens L3 are reduced and it becomes difficult to correct curvature of field and astigmatism. In a case where the shape factor of the fourth lens L4 becomes lower than the lower limit of inequality (2), the positive refractive power of the observation-side surface of the fourth lens L4 is reduced, the rear principal point separates from the observation position, and it becomes difficult to increase the eye relief.

The lower limit of inequality (2) may be set to −3.00, −2.00, −1.50 or −1.30. The upper limit of inequality (2) may be set to −0.195 or −0.20.

Inequality (3) defines a proper relationship between the air-equivalent distance L1 from the display surface IP to the first lens L1 and the distance LD from the first lens L1 to the fourth lens L4. In a case where the air-equivalent distance L1 from the display surface IP to the first lens L1 increases so that LD/L1 becomes lower than the lower limit of inequality (3), the focal length of the entire display optical system L0 increases and it becomes difficult to achieve high magnification ratio. In a case where the distance LD from the first lens L1 to the fourth lens L4 increases so that LD/L1 becomes higher than the upper limit of inequality (3), the size of the display optical system L0 increases.

The lower limit of inequality (3) may be set to 1.0, 1.5, or 2.0. The upper limit of inequality (3) may be set to 30.0, 20.0, 10.0, 5.0, or 4.0.

The display optical system L0 according to each example includes the above configuration and satisfies inequalities (1) to (3), and thus has a high magnification, sufficient eye relief, and reduced size.

The display optical system L0 according to each example may satisfy at least one of the following inequalities (4) to (10):

$$0.10 \leq f 4 / f \leq 5. \qquad ( 4 )$$

$$- 5. \leq f / f 3 \leq 0.50 \qquad ( 5 )$$

$$- 2. 0 \leq f 2 / f 3 \leq 5. \qquad ( 6 )$$

$$- 50. 0 \leq ( R 32 + R 31 ) / ( R 32 - R 31 ) \leq - 0.1 \qquad ( 7 )$$

$$0.8 \leq LD / f \leq 3. \qquad ( 8 )$$

$$0.3 \leq H / f \leq 0.50 \qquad ( 9 )$$

$$0.3 \leq 2 \times He / φ \leq 0.8 \qquad ( 10 )$$

In inequalities (4) to (10), f is a focal length of the entire display optical system L0, f4 is a focal length of the fourth lens L4, f3 is a focal length of the third lens L3, and f2 is a focal length of the second lens L2. R31 is a radius of curvature of a display-element-side surface of the third lens L3, and R32 is a radius of curvature of an observation-side surface of the surface of the third lens L3. H is a half diagonal length of the display surface IP of the display element. Each of the first to fourth lenses may include an aspheric lens having an inflection point on one of the display-element-side surface and the observation-side surface, He is a height of the inflection point from the optical axis of the aspheric lens, and o is an effective diameter of the surface having the inflection point of the aspheric lens. An inflection point of a surface is a point where the sign of the curvature of the surface changes and the curvature becomes 0 (a point (line) where the slope of the surface becomes 0 and the sign of the slope of the surface changes between the optical axis side and the peripheral side of that point). An effective diameter of a surface is a radius of an area of the surface through which light rays contribute to imaging pass.

Inequality (4) defines a proper relationship between the focal length f4 of the fourth lens L4 and the focal length f of the entire display optical system L0. This inequality is a condition for achieving both the one-sided blur sensitivity of the display optical system L0 (a magnitude of a one-sided blur amount that occurs when the display optical system L0 is tilted) and the correction of a variety of aberrations such as curvature of field and astigmatism. In a case where f4/f becomes higher than the upper limit of inequality (4), the refractive power of the entire display optical system L0 increases, the one-sided blur sensitivity of the display optical system L0 increases, and the manufacturing difficulty increases. In a case where f4/f becomes lower than the lower limit of inequality (4), the refractive power of the fourth lens L4 increases, and a variety of aberrations such as curvature of field and astigmatism increase.

The lower limit of inequality (4) may be set to 0.20, 0.30, or 0.40. The upper limit of inequality (4) may be set to 4.0, 3.0, 2.0, or 1.8.

Inequality (5) defines a proper relationship between the focal length f3 of the third lens L3 and the focal length f of the entire display optical system L0. This inequality is a condition for securing high magnification and sufficient eye relief while satisfactorily correcting a variety of aberrations such as curvature of field and astigmatism. In a case where f/f3 becomes higher than the upper limit of inequality (5), the positive refractive power of the third lens L3 increases, the Petzval sum of the display optical system L0 increases, and it becomes difficult to correct a variety of aberrations such as curvature of field and astigmatism. In a case where f3/f becomes lower than the lower limit of inequality (5), the negative refractive power of the third lens L3 increases, positive refractive power of the entire display optical system L0 runs short, and it becomes difficult to achieve high magnification.

The lower limit of inequality (5) may be set to −4.00, −3.00, or −2.00. The upper limit of inequality (5) may be set to 0.30, 0.20, or 0.10.

Inequality (6) defines a proper relationship between the focal length f2 of the second lens L2 and the focal length f3 of the third lens L3. This inequality is a condition for securing high magnification and sufficient eye relief while satisfactorily correcting a variety of aberrations such as curvature of field, astigmatism, and lateral aberration. In a case where f2/f3 becomes higher than the upper limit of inequality (6), the negative refractive power of the third lens L3 is reduced, the Petzval sum of the display optical system L0 increases, and it becomes difficult to correct a variety of aberrations such as curvature of field and astigmatism. In a case where f2/f3 becomes lower than the lower limit of inequality (6), the refractive power of the second lens L2 becomes insufficient, and it becomes difficult to correct lateral aberration.

The lower limit of inequality (6) may be set to −1.00, −0.50, −0.20, or −0.15. The upper limit of inequality (6) may be set to 4.50, 4.00, 3.50, or 3.10.

Inequality (7) defines a proper shape factor of the third lens L3, and indicates a condition for achieving both high magnification of the display optical system L0 and correction of various aberrations such as curvature of field, astigmatism, and distortion. In a case where the shape factor of the third lens L3 becomes higher than the upper limit of inequality (7), it becomes difficult to correct a variety of aberrations such as curvature of field and astigmatism. In a case where the shape factor of the third lens L3 becomes lower than the lower limit of inequality (7), it becomes difficult to correct distortion.

The lower limit of inequality (7) may be set to −40.0, −37.0, or −35.0. The upper limit of inequality (7) may be set to −0.2, −0.4, or −0.6.

Inequality (8) defines a proper relationship between the thickness LD of the entire display optical system L0 and the focal length f of the entire display optical system L0. This inequality is a condition for achieving both high magnification of the display optical system L0 and correction of a variety of aberrations such as spherical aberration and lateral aberration. In a case where LD/f becomes higher than the upper limit of inequality (8), the thickness of the display optical system L0 increases, and it becomes difficult to achieve high magnification. In a case where LD/f becomes lower than the lower limit of inequality (8), a proper curvature for each lens cannot be set, and it becomes difficult to correct a variety of aberrations such as spherical aberration and lateral aberration.

The lower limit of inequality (8) may be set to 0.9, 1.0, or 1.1. The upper limit of inequality (8) may be set to 2.0, 1.5, or 1.3.

Inequality (9) defines a proper relationship between half the diagonal length H of the display surface IP and the focal length f of the entire display optical system L0. This inequality is a condition for achieving both a wide angle of field and correction of a variety of aberrations such as spherical aberration, curvature of field, and astigmatism. In a case where H/f becomes higher than the upper limit of inequality (9), the magnification of the display optical system L0 increases, and it becomes difficult to correct various aberrations such as spherical aberration, curvature of field, and astigmatism. In a case where H/f becomes lower than the lower limit of inequality (9), it becomes difficult to achieve a wide angle of field.

The lower limit of inequality (9) may be set to 0.32, 0.35, or 0.38. The upper limit of inequality (9) may be set to 0.48, 0.45, or 0.42.

Inequality (10) defines a proper relationship between the height He of the inflection point in the aspheric lens and the effective diameter φ of the surface having the inflection point. In a case where 2×He/φ becomes higher than the upper limit of inequality (10), the inflection point of the aspheric lens cannot be located inside the lens surface, it becomes difficult to correct curvature of field and astigmatism in an intermediate area of the field. In a case where 2×He/φ becomes lower than the lower limit of inequality (10), the inflection point of the aspheric lens approaches the optical axis, and it becomes difficult to correct curvature of field and astigmatism in the intermediate area of the field.

The lower limit of inequality (10) may be set to 0.4, 0.45, or 0.5. The upper limit of inequality (10) may be set to 0.79, 0.78 or 0.77.

Numerical examples 1 to 10 will be illustrated below. In each numerical example, surface number i represents the order of a surface counted from the object side. The first surface is the display surface IP of the display element, and the second surface in numerical examples 1, 2, and 4 to 10 is an observation-side surface of the first cover glass CG1. r represents a radius of curvature of an i-th surface (mm), d represents a lens thickness or distance (air gap) (mm) on the optical axis between i-th and (i+1)-th surfaces. nd represents a refractive index for the d-line of an optical material between i-th and (i+1)-th surfaces. νd is an Abbe number based on the d-line of an optical material between i-th and (i+1)-th surfaces. The Abbe number νd based on the d-line is expressed as follows:

$$vd = ( Nd - 1 ) / ( NF - NC )$$

where Nd, NF, and NC are refractive indices for the d-line (587.6 nm), F-line (486.1 nm), and C-line (656.3 nm), respectively.

φ is an effective diameter of an i-th surface.

A focal length f (mm) is a focal length of the entire display optical system L0, and a display diagonal length (mm) is a diagonal length (2×H) of the display surface IP. An apparent field of view (°) represents a half angle of view ω (°) of the display optical system L0, and 2ω is an angle of field (°) as a full angle of view.

An asterisk “*” next to a surface number means that the surface has an aspheric shape. The aspheric shape is expressed by the following equation:

$$x = ( {h}^{2} / r ) / [ 1 + √ \{ 1 - ( 1 + k ) {( h / R )}^{2} \} ] + A 2 \times {h}^{2} + A 4 \times {h}^{4} + A 6 \times {h}^{6} + A 8 \times {h}^{8} + A 8 \times {h}^{8} + A 10 \times {h}^{10} + A 12 \times {h}^{12}$$

where x is a displacement amount from a surface vertex in the optical axis direction, h is a height from the optical axis in a direction orthogonal to the optical axis, a light traveling direction is positive, r is a paraxial radius of curvature, K is a conic constant, and A4, A6, A8, A10, and A12 are aspheric coefficients.

The “e±M” in the conic constant and aspheric coefficient means ×10^{±M}.

Each numerical example illustrates the focal length of each lens and the diopter to be adjusted by moving the display element ID itself, which moves the entire display optical system relative to the display element ID, to change a distance between the second surface and the third surface (the object-side lens surface of the first lens 1).

Table 1 summarizes values corresponding to inequalities (1) to (10) in numerical examples 1 to 10. Each of numerical examples satisfies all of inequalities (1) to (10).

FIGS. 2, 4, 6, 8, 10, 12, 14, 16, 18 and 20 respectively illustrate the longitudinal aberration (spherical aberration, astigmatism, distortion, and chromatic aberration) in a case where the diopter of the display optical systems according to numerical examples 1 to 10 is set to −1.0 diopter (standard diopter). In the spherical aberration diagrams, a pupil diameter is 10 mm or 7.59 mm, a solid line illustrates a spherical aberration amount for the d-line (with a wavelength of 587.6 nm) and a long and two short dashes line illustrates a spherical aberration amount for the F-line (with a wavelength of 486.1 nm). In the astigmatism diagram, a solid line S indicates an astigmatism amount on a sagittal image plane, and a broken line M indicates an astigmatism amount on a meridional image plane. The distortion diagram illustrates the distortion at the d-line. The chromatic aberration diagram illustrates a lateral chromatic aberration amount for the F-line. H is a half diagonal length of the display surface (maximum image height).

NUMERICAL EXAMPLE 1
UNIT: mm
SURFACE DATA

| Surface No. | r | d | nd | νd | φ |
|---|---|---|---|---|---|
| 1 | ∞ | 0.50 | 1.52100 | 65.1 | |
| 2 | ∞ | (Variable) | | | |
| 3* | 376.116 | 10.00 | 1.76802 | 49.2 | 23.7 |
| 4* | −8.765 | 3.36 | | | 25.8 |
| 5* | −14.720 | 1.00 | 1.63540 | 23.9 | 20.8 |
| 6* | −68.410 | 2.00 | | | 24.4 |
| 7* | −11.368 | 5.51 | 1.53500 | 56.0 | 25.4 |
| 8* | −14.724 | 0.30 | | | 25.8 |
| 9* | 17.798 | 3.88 | 1.53500 | 56.0 | 22.9 |
| 10* | −61.298 | (Variable) | | | 22.7 |
| 11 | ∞ | 0.80 | 1.49171 | 57.4 | |
| 12 | ∞ | 23.00 | | | |
| 13 | (eye point) | | | | |

ASPHERIC DATA
3rd Surface
K = −1.89164e+05 A 4 = −5.02068e−05 A 6 = 5.62461e−07 A 8 = −3.83199e−09
A10 = 8.20913e−12
4th Surface
K = −3.27897e+00 A 4 = −6.79417e−05 A 6 = 7.94990e−08 A 8 = 1.08833e−11
A10 = −2.87555e−12
5th Surface
K = −1.64110e+01 A 4 = −2.55131e−04 A 6 = −1.27690e−06 A 8 = 9.09432e−09
A10 = −3.01778e−12
6th Surface
K = −9.50543e+00 A 2 = 3.36298e−02 A 4 = −4.33191e−04 A 6 = 2.31754e−06
A8 = −5.71593e−09 A10 = 5.28515e−12
7th Surface
K = −8.70412e+00 A 4 = 1.42829e−04 A 6 = −2.77784e−07 A 8 = −8.50853e−10
A10 = 2.58965e−12 A12 = −1.61740e−15
8th Surface
K = −3.47459e+00 A 4 = −4.58612e−05 A 6 = −4.67695e−07 A 8 = 5.98832e−09
A10 = −2.70281e−11 A12 = 4.19776e−14
9th Surface
K = −8.60151e+00 A 4 = −1.26506e−04 A 6 = 1.92372e−06 A 8 = −2.00432e−08
A10 = 6.77368e−11
10th Surface
K = −8.66410e+01 A 4 = −1.29062e−04 A 6 = 1.89353e−06 A 8 = −1.70580e−08
A10 = 5.44821e−11
VARIOUS DATA

| | | | |
|---|---|---|---|
| Diopter (D) | −1.00 | −4.00 | +2.00 |
| Focal Length | 20.28 | 20.28 | 20.28 |
| Display Diagonal | 16.20 | 16.20 | 16.20 |
| Length (mm) | | | |
| Apparent field | 21.33 | 20.20 | 22.46 |
| of view (°) | | | |
| d2 | 6.57 | 5.21 | 7.78 |
| d10 | 2.11 | 3.38 | 0.70 |

NUMERICAL EXAMPLE 2
UNIT: mm
SURFACE DATA

| Surface No. | r | d | nd | νd | φ |
|---|---|---|---|---|---|
| 1 | ∞ | 0.50 | 1.52100 | 65.1 | 24.0 |
| 2 | ∞ | (Variable) | | | |
| 3* | 513.859 | 9.31 | 1.76802 | 49.2 | 24.0 |
| 4* | −8.365 | 3.24 | | | 25.7 |
| 5* | −14.757 | 1.00 | 1.63540 | 23.9 | 20.7 |
| 6* | −182.926 | 1.90 | | | 24.5 |
| 7* | −14.553 | 6.00 | 1.53500 | 56.0 | 26.0 |
| 8* | −18.071 | 0.35 | | | 26.1 |
| 9* | 16.857 | 3.91 | 1.53500 | 56.0 | 22.2 |
| 10* | −59.514 | (Variable) | | | 21.6 |
| 11 | ∞ | 0.80 | 1.49171 | 57.4 | |
| 12 | ∞ | 23.00 | | | |
| 13 | (eye point) | | | | |

ASPHERIC DATA
3rd Surface
K = −5.54471e+05 A 4 = −9.25184e−05 A 6 = 1.09708e−06 A 8 = −6.38694e−09
A10 = 1.26580e−11
4th Surface
K = −3.41127e+00 A 4 = −8.97690e−05 A 6 = 2.88068e−07 A 8 = −8.42500e−10
A10 = −1.75989e−12
5th Surface
K = −2.02579e+01 A 4 = −2.04836e−04 A 6 = −1.92237e−06 A 8 = 1.03788e−08
A10 = 3.07955e−12
6th Surface
K = 1.87220e+02 A 2 = 3.66874e−02 A 4 = −4.92639e−04 A 6 = 2.14900e−06
A 8 = 5.67822e−10 A10 = −1.67267e−11
7th Surface
K = −1.37291e+01 A 4 = 1.13408e−04 A 6 = 5.56589e−08 A 8 = −7.42850e−10
A10 = −6.13332e−12 A12 = 3.08258e−14
8th Surface
K = −4.78849e+00 A 4 = −2.96841e−05 A 6 = −5.38377e−07 A 8 = 4.51576e−09
A10 = −2.21221e−11 A12 = 6.33920e−14
9th Surface
K = −7.00279e+00 A 4 = −3.57300e−05 A 6 = 2.08429e−06 A 8 = −2.41742e−08
A10 = 8.35094e−11
10th Surface
K = −9.04274e+01 A 4 = −7.36519e−05 A 6 = 2.75506e−06 A 8 = −2.57115e−08
A10 = 8.37098e−11
VARIOUS DATA

| | | | |
|---|---|---|---|
| Diopter (D) | −1.00 | −4.00 | +2.00 |
| Focal Length | 20.28 | 20.28 | 20.28 |
| Display Diagonal | 16.20 | 16.20 | 16.20 |
| Length (mm) | | | |
| Apparent field | 21.28 | 20.14 | 22.41 |
| of view (°) | | | |
| d2 | 6.92 | 5.56 | 8.13 |
| d10 | 2.08 | 3.38 | 0.70 |

NUMERICAL EXAMPLE 3
UNIT: mm
SURFACE DATA

| Surface No. | r | d | nd | νd | φ |
|---|---|---|---|---|---|
| 1 | ∞ | (Variable) | | | |
| 2* | 18.739 | 10.66 | 1.76802 | 49.2 | 27.2 |
| 3* | −11.259 | 2.78 | | | 27.1 |
| 4* | −5.388 | 1.00 | 1.63540 | 23.9 | 23.3 |
| 5* | −50.632 | 1.00 | | | 23.3 |
| 6* | −7.892 | 1.61 | 1.53500 | 56.0 | 23.3 |
| 7* | 66.883 | 1.00 | | | 22.7 |
| 8* | 5.828 | 5.66 | 1.53500 | 56.0 | 20.8 |
| 9* | −35.025 | (Variable) | | | 20.0 |
| 10 | (eye point) | | | | |

ASPHERIC DATA
2nd Surface
K = 2.26455e−01 A 4 = −5.68837e−05 A 6 = −1.19209e−07 A 8 = 1.11644e−09
A10 = −4.02931e−12
3rd Surface
K = −6.67505e+00 A 4 = −5.99596e−05 A 6 = 3.81109e−07 A 8 = −1.37120e−09
A10 = 1.63789e−12
4th Surface
K = −4.28005e+00 A 4 = −5.05845e−05 A 6 = 1.77765e−07 A 8 = −1.08490e−09
A10 = 2.90458e−12
5th Surface
K = 0.00000e+00 A 4 = 1.38981e−04 A 6 = −9.94031e−07 A 8 = 3.30110e−09
A10 = −3.87427e−12
6th Surface
K = −1.23392e+01 A 4 = 2.39087e−04 A 6 = −1.26320e−06 A 8 = 3.45854e−09
A10 = −2.49234e−12
7th Surface
K = 0.00000e+00 A 4 = 4.86520e−05 A 6 = −9.80939e−07 A 8 = 3.36450e−09
A10 = −2.72016e−12
8th Surface
K = −5.26844e+00 A 4 = 4.13928e−05 A 6 = −3.15514e−07 A 8 = 1.50115e−09
A10 = −9.54206e−12
9th Surface
K = −3.54234e+01 A 4 = 4.45326e−05 A 6 = 6.44307e−09 A 8 = 1.75263e−09
A10 = −7.41726e−12
VARIOUS DATA

| | | | |
|---|---|---|---|
| Diopter (D) | −1.00 | −4.00 | +2.00 |
| Focal Length | 20.37 | 20.37 | 20.37 |
| Display Diagonal | 16.20 | 16.20 | 16.20 |
| Length (mm) | | | |
| Apparent field | 21.44 | 20.35 | 22.26 |
| of view (°) | | | |
| d1 | 11.41 | 10.03 | 12.45 |
| d9 | 25.00 | 26.38 | 23.96 |

NUMERICAL EXAMPLE 4
UNIT: mm
SURFACE DATA

| Surface No. | r | d | nd | νd | φ |
|---|---|---|---|---|---|
| 1 | ∞ | 0.50 | 1.52100 | 65.1 | |
| 2 | ∞ | (Variable) | | | |
| 3* | 24.387 | 9.56 | 1.76802 | 49.2 | 28.2 |
| 4* | −13.114 | 3.94 | | | 28.4 |
| 5* | −6.015 | 1.00 | 1.63540 | 23.9 | 23.0 |
| 6* | −26.987 | 1.33 | | | 24.3 |
| 7* | −9.756 | 3.64 | 1.53500 | 56.0 | 24.7 |
| 8* | −16.671 | 0.50 | | | 24.5 |
| 9* | 10.122 | 4.33 | 1.53500 | 56.0 | 22.0 |
| 10* | −106.049 | (Variable) | | | 21.7 |
| 11 | ∞ | 0.80 | 1.49171 | 57.4 | |
| 12 | ∞ | 23.00 | | | |
| 13 | (eye point) | | | | |

ASPHERIC DATA
3rd Surface
K = 6.70822e−01 A 4 = −5.00618e−05 A 6 = −1.18474e−07 A 8 = 1.13930e−09
A10 = −4.53268e−12 A12 = 5.04919e−15
4th Surface
K = −4.54994e+00 A 4 = −6.06901e−05 A 6 = 2.57069e−07 A 8 = −1.15658e−09
A10 = 3.08087e−12 A12 = −4.68990e−15
5th Surface
K = −2.71187e+00 A 4 = −6.42669e−05 A 6 = 3.16971e−07 A 8 = −2.28961e−09
A10 = 6.08757e−12 A12 = 9.41133e−15
6th Surface
K = 9.01337e−01 A 4 = 1.63743e−04 A 6 = −9.99798e−07 A 8 = 3.69695e−09
A10 = −5.04138e−12 A12 = 2.72274e−15
7th Surface
K = −7.76278e+00 A 4 = 2.21440e−04 A 6 = −1.18424e−06 A 8 = 3.71999e−09
A10 = −1.05764e−12 A12 = −7.47856e−15
8th Surface
K = −6.41891e+00 A 4 = 7.36232e−05 A 6 = −8.33475e−07 A 8 = 4.09237e−09
A10 = −6.74545e−12 A12 = 6.89504e−15
9th Surface
K = −5.62166e+00 A 4 = −2.54994e−05 A 6 = 2.09700e−07 A 8 = −3.08453e−09
A10 = −3.76948e−11 A12 = 2.70052e−13
10th Surface
K = 4.16435e+01 A 4 = 1.50868e−05 A 6 = 1.97823e−07 A 8 = −3.97950e−09
A10 = −1.31872e−11 A12 = 1.64345e−13
VARIOUS DATA

| | | | |
|---|---|---|---|
| Diopter (D) | −1.00 | −4.00 | +2.00 |
| Focal Length | 20.37 | 20.37 | 20.37 |
| Display Diagonal | 16.40 | 16.40 | 16.40 |
| Length (mm) | | | |
| Apparent field | 21.25 | 20.08 | 22.38 |
| of view (°) | | | |
| d2 | 9.18 | 7.79 | 10.40 |
| d10 | 1.67 | 3.07 | 0.70 |

NUMERICAL EXAMPLE 5
UNIT: mm
SURFACE DATA

| Surface No. | r | d | nd | νd | φ |
|---|---|---|---|---|---|
| 1 | ∞ | 0.50 | 1.52100 | 65.1 | |
| 2 | ∞ | (Variable) | | | |
| 3* | 20.197 | 9.85 | 1.76802 | 49.2 | 27.7 |
| 4* | −13.690 | 3.67 | | | 27.8 |
| 5* | −5.580 | 1.00 | 1.63540 | 23.9 | 23.2 |
| 6* | −88.973 | 1.34 | | | 23.3 |
| 7* | −10.081 | 2.59 | 1.63540 | 23.9 | 23.3 |
| 8* | −12.105 | 0.30 | | | 23.4 |
| 9* | 11.208 | 5.50 | 1.53500 | 56.0 | 23.4 |
| 10* | −36.282 | (Variable) | | | 23.4 |
| 11 | ∞ | 0.80 | 1.49171 | 57.4 | |
| 12 | ∞ | 23.00 | | | |
| 13 | (eye point) | | | | |

ASPHERIC DATA
3rd Surface
K = 3.87413e−01 A 4 = −3.89860e−05 A 6 = −8.67976e−08 A 8 = 8.28362e−10
A10 = −5.30948e−12 A12 = 4.80023e−15
4th Surface
K = −4.89947e+00 A 4 = −3.68131e−05 A 6 = 2.03082e−07 A 8 = −1.11227e−09
A10 = 3.58940e−12 A12 = −7.29729e−15
5th Surface
K = −2.37322e+00 A 4 = −7.28159e−06 A 6 = 3.55254e−07 A 8 = −3.51693e−09
A10 = 1.76606e−11 A12 = −4.11756e−14
6th Surface
K = −1.49948e+01 A 4 = 1.85571e−04 A 6 = −1.26406e−06 A 8 = 5.01073e−09
A10 = −8.97244e−12 A12 = −9.97681e−16
7th Surface
K = −1.10608e+01 A 4 = 2.49744e−04 A 6 = −1.10783e−06 A 8 = 2.41642e−09
A10 = 7.66818e−12 A12 = −7.77741e−14
8th Surface
K = −2.09391e+00 A 4 = 1.89660e−04 A 6 = −3.28364e−07 A 8 = 3.68979e−09
A10 = −3.01581e−11 A12 = 3.23950e−14
9th Surface
K = −1.00450e+01 A 4 = −1.07204e−04 A 6 = 6.80934e−07 A 8 = −2.98798e−09
A10 = −3.73369e−12 A12 = 4.16627e−14
10th Surface
K = 2.35431e+00 A 4 = −5.53434e−05 A 6 = 8.92519e−08 A 8 = 6.92353e−10
A10 = −1.11632e−11 A12 = 3.76060e−14
VARIOUS DATA

| | | | |
|---|---|---|---|
| Diopter (D) | −1.00 | −4.00 | +2.00 |
| Focal Length | 20.37 | 20.37 | 20.37 |
| Display Diagonal | 16.20 | 16.20 | 16.20 |
| Length (mm) | | | |
| Apparent field | 21.10 | 20.02 | 22.05 |
| of view (°) | | | |
| d2 | 9.21 | 7.81 | 10.43 |
| d10 | 1.78 | 3.08 | 0.70 |

NUMERICAL EXAMPLE 6
UNIT: mm
SURFACE DATA

| Surface No. | r | d | nd | νd | φ |
|---|---|---|---|---|---|
| 1 | ∞ | 0.50 | 1.52100 | 65.1 | |
| 2 | ∞ | (Variable) | | | |
| 3* | 397.212 | 10.00 | 1.76802 | 49.2 | 23.5 |
| 4* | −8.822 | 3.32 | | | 25.7 |
| 5* | −15.026 | 1.00 | 1.63540 | 23.9 | 20.8 |
| 6* | −51.662 | 1.97 | | | 24.5 |
| 7* | −12.387 | 5.95 | 1.53500 | 56.0 | 25.5 |
| 8* | −13.147 | 0.30 | | | 25.9 |
| 9* | 20.995 | 3.53 | 1.53500 | 56.0 | 22.9 |
| 10* | −93.552 | (Variable) | | | 22.7 |
| 11 | ∞ | 0.80 | 1.49171 | 57.4 | |
| 12 | ∞ | 23.00 | | | |
| 13 | (eye point) | | | | |

ASPHERIC DATA
3rd Surface
K = −2.23533e+05 A 4 = −4.68928e−05 A 6 = 4.85224e−07 A 8 = −3.74330e−09
A10 = 8.78146e−12
4th Surface
K = −3.30000e+00 A 4 = −6.70728e−05 A 6 = 6.09390e−08 A 8 = 3.44398e−11
A10 = −3.09088e−12
5th Surface
K = −1.71486e+01 A 4 = −2.69762e−04 A 6 = −1.01007e−06 A 8 = 6.53288e−09
A10 = 5.80030e−12
6th Surface
K = −5.48685e+00 A 2 = 3.61488e−02 A 4 = −4.35401e−04 A 6 = 2.34055e−06
A 8 = −6.10400e−09 A10 = 6.82350e−12
7th Surface
K = −9.05184e+00 A 4 = 1.24223e−04 A 6 = −1.68995e−07 A 8 = −9.08025e−10
A10 = 1.59955e−12 A12 = 3.95063e−16
8th Surface
K = −2.54933e+00 A 4 = −2.73555e−05 A 6 = −5.18865e−07 A 8 = 6.01841e−09
A10 = −2.58214e−11 A12 = 3.70967e−14
9th Surface
K = −8.08215e+00 A 4 = −1.50436e−04 A 6 = 2.03581e−06 A 8 = −1.98158e−08
A10 = 6.54008e−11
10th Surface
K = 2.12130e+01 A 4 = −1.24533e−04 A 6 = 1.80098e−06 A 8 = −1.59562e−08
A10 = 5.08091e−11
VARIOUS DATA

| | | | |
|---|---|---|---|
| Diopter (D) | −1.00 | −4.00 | +2.00 |
| Focal Length | 20.28 | 20.28 | 20.28 |
| Display Diagonal | 16.20 | 16.20 | 16.20 |
| Length (mm) | | | |
| Apparent field | 21.36 | 20.24 | 22.47 |
| of view (°) | | | |
| d2 | 6.55 | 5.20 | 7.77 |
| d10 | 2.11 | 3.38 | 0.70 |

NUMERICAL EXAMPLE 7
UNIT: mm
SURFACE DATA

| Surface No. | r | d | nd | νd | φ |
|---|---|---|---|---|---|
| 1 | ∞ | 0.50 | 1.52100 | 65.1 | |
| 2 | ∞ | (Variable) | | | |
| 3* | 425.161 | 9.79 | 1.76802 | 49.2 | 23.4 |
| 4* | −8.696 | 3.06 | | | 25.4 |
| 5* | −15.539 | 1.38 | 1.63540 | 23.9 | 20.8 |
| 6* | −50.461 | 2.06 | | | 24.5 |
| 7* | −10.428 | 6.00 | 1.53500 | 56.0 | 25.5 |
| 8* | −11.804 | 0.30 | | | 25.8 |
| 9* | 16.937 | 3.22 | 1.53500 | 56.0 | 22.6 |
| 10* | 170.326 | (Variable) | | | 22.2 |
| 11 | ∞ | 0.80 | 1.49171 | 57.4 | |
| 12 | ∞ | 23.00 | | | |
| 13 | (eye point) | | | | |

ASPHERIC DATA
3rd Surface
K = −2.95506e+05 A 4 = −3.47748e−05 A 6 = 4.31092e−07 A 8 = −3.59952e−09
A10 = 8.15728e−12
4th Surface
K = −3.32024e+00 A 4 = −5.92942e−05 A 6 = 2.60604e−08 A 8 = 2.25111e−10
A10 = −3.75703e−12
5th Surface
K = −1.61589e+01 A 4 = −2.51907e−04 A 6 = −1.56356e−06 A 8 = 1.21736e−08
A10 = −1.05361e−11
6th Surface
K = −3.04191e+00 A 2 = 3.52360e−02 A 4 = −4.26318e−04 A 6 = 2.40118e−06
A 8 = −6.83282e−09 A10 = 8.59899e−12
7th Surface
K = −8.88090e+00 A 4 = 1.31777e−04 A 6 = −2.09126e−07 A 8 = −7.94830e−10
A10 = 2.34009e−12 A12 = 9.58615e−16
8th Surface
K = −1.95219e+00 A 4 = −1.07224e−05 A 6 = −4.41017e−07 A 8 = 5.82392e−09
A10 = −2.74169e−11 A12 = 4.79560e−14
9th Surface
K = −1.16423e+01 A 4 = −1.71690e−04 A 6 = 1.98413e−06 A 8 = −1.70396e−08
A10 = 6.04553e−11
10th Surface
K = −3.71617e+03 A 4 = −2.17353e−04 A 6 = 2.39597e−06 A 8 = −1.78623e−08
A10 = 5.93749e−11
VARIOUS DATA

| | | | |
|---|---|---|---|
| Diopter (D) | −1.00 | −4.00 | +2.00 |
| Focal Length | 20.28 | 20.28 | 20.28 |
| Display Diagonal | 16.20 | 16.20 | 16.20 |
| Length (mm) | | | |
| Apparent field | 21.33 | 20.25 | 22.40 |
| of view (°) | | | |
| d2 | 6.81 | 5.46 | 8.03 |
| d10 | 2.03 | 3.38 | 0.70 |

NUMERICAL EXAMPLE 8
UNIT: mm
SURFACE DATA

| Surface No. | r | d | nd | νd | φ |
|---|---|---|---|---|---|
| 1 | ∞ | 0.50 | 1.52100 | 65.1 | |
| 2 | ∞ | (Variable) | | | |
| 3* | 384.091 | 10.00 | 1.76802 | 49.2 | 23.4 |
| 4* | −8.547 | 3.00 | | | 25.5 |
| 5* | −14.856 | 1.00 | 1.63540 | 23.9 | 20.5 |
| 6* | −83.067 | 1.94 | | | 24.0 |
| 7* | −12.617 | 5.65 | 1.53500 | 56.0 | 24.9 |
| 8* | −14.789 | 0.30 | | | 25.4 |
| 9* | 24.857 | 4.06 | 1.53500 | 56.0 | 23.3 |
| 10* | −37.365 | (Variable) | | | 23.2 |
| 11 | ∞ | 0.80 | 1.49171 | 57.4 | |
| 12 | ∞ | 23.00 | | | |
| 13 | (eye point) | | | | |

ASPHERIC DATA
3rd Surface
K = −2.17733e+05 A 4 = −5.11908e−05 A 6 = 5.60697e−07 A 8 = −3.78838e−09
A10 = 8.04770e−12
4th Surface
K = −3.36508e+00 A 4 = −6.93029e−05 A 6 = 7.67309e−08 A 8 = 1.32288e−11
A10 = −2.96058e−12
5th Surface
K = −1.73943e+01 A 4 = −2.61688e−04 A 6 = −1.27273e−06 A 8 = 8.76287e−09
A10 = 2.95618e−12
6th Surface
K = 1.33446e+01 A 2 = 3.42425e−02 A 4 = −4.42056e−04 A 6 = 2.36438e−06
A 8 = −5.70590e−09 A10 = 5.94429e−12
7th Surface
K = −9.58046e+00 A 4 = 1.42666e−04 A 6 = −2.63028e−07 A 8 = −8.54596e−10
A10 = 2.74952e−12 A12 = −4.31377e−15
8th Surface
K = −4.68902e+00 A 4 = −4.32305e−05 A 6 = −4.87542e−07 A 8 = 6.12324e−09
A10 = −2.73575e−11 A12 = 4.00571e−14
9th Surface
K = −7.67937e+00 A 4 = −1.23119e−04 A 6 = 1.86970e−06 A 8 = −1.96532e−08
A10 = 6.46920e−11
10th Surface
K = −2.70481e+01 A 4 = −1.30006e−04 A 6 = 1.91854e−06 A 8 = −1.68608e−08
A10 = 5.12757e−11
VARIOUS DATA

| | | | |
|---|---|---|---|
| Diopter (D) | −1.00 | −4.00 | +2.00 |
| Focal Length | 20.28 | 20.28 | 20.28 |
| Apparent field | 21.36 | 20.27 | 22.43 |
| of view (°) | | | |
| Display Diagonal | 16.20 | 16.20 | 16.20 |
| Length (mm) | | | |
| d2 | 6.51 | 5.16 | 7.73 |
| d10 | 2.09 | 3.38 | 0.70 |

NUMERICAL EXAMPLE 9
UNIT: mm
SURFACE DATA

| Surface No. | r | d | nd | νd | φ |
|---|---|---|---|---|---|
| 1 | ∞ | 0.50 | 1.52100 | 65.1 | |
| 2 | ∞ | (Variable) | | | |
| 3* | 381.662 | 9.96 | 1.76802 | 49.2 | 23.6 |
| 4* | −8.609 | 3.11 | | | 25.6 |
| 5* | −15.078 | 1.01 | 1.63540 | 23.9 | 20.8 |
| 6* | −64.767 | 2.26 | | | 24.4 |
| 7* | −10.579 | 6.00 | 1.53500 | 56.0 | 25.5 |
| 8* | −12.817 | 0.30 | | | 25.9 |
| 9* | 15.940 | 3.29 | 1.53500 | 56.0 | 22.5 |
| 10* | 253.550 | (Variable) | | | 22.1 |
| 11 | ∞ | 0.80 | 1.49171 | 57.4 | |
| 12 | ∞ | 23.00 | | | |
| 13 | (eye point) | | | | |

ASPHERIC DATA
3rd Surface
K = −1.87125e+05 A 4 = −4.91444e−05 A 6 = 5.57210e−07 A 8 = −3.81933e−09
A10 = 7.99736e−12
4th Surface
K = −3.30596e+00 A 4 = −6.66232e−05 A 6 = 8.51735e−08 A 8 = −6.13695e−12
A10 = −3.08901e−12
5th Surface
K = −1.59486e+01 A 4 = −2.50965e−04 A 6 = −1.37055e−06 A 8 = 9.52523e−09
A10 = −1.95386e−12
6th Surface
K = −8.65996e+00 A 2 = 3.29093e−02 A 4 = −4.25197e−04 A 6 = 2.34596e−06
A 8 = −6.28200e−09 A10 = 7.02474e−12
7th Surface
K = −9.02297e+00 A 4 = 1.41144e−04 A 6 = −2.61141e−07 A 8 = −8.54577e−10
A10 = 3.00635e−12 A12 = −1.59596e−15
8th Surface
K = −2.27918e+00 A 4 = −2.93589e−05 A 6 = −4.19851e−07 A 8 = 5.86368e−09
A10 = −2.76518e−11 A12 = 4.60724e−14
9th Surface
K = −8.82778e+00 A 4 = −1.63479e−04 A 6 = 2.03969e−06 A 8 = −1.89952e−08
A10 = 6.81850e−11
10th Surface
K = −6.23994e+03 A 4 = −1.75794e−04 A 6 = 2.08448e−06 A 8 = −1.73037e−08
A10 = 6.03257e−11
VARIOUS DATA

| | | | |
|---|---|---|---|
| Diopter (D) | −1.00 | −4.00 | +2.00 |
| Focal Length | 20.28 | 20.28 | 20.28 |
| Apparent field | 21.31 | 20.22 | 22.41 |
| of view (°) | | | |
| Display Diagonal | 16.20 | 16.20 | 16.20 |
| Length (mm) | | | |
| d2 | 6.70 | 5.34 | 7.91 |
| d10 | 2.11 | 3.38 | 0.70 |

NUMERICAL EXAMPLE 10
UNIT: mm
SURFACE DATA

| Surface No. | r | d | nd | νd | φ |
|---|---|---|---|---|---|
| 1 | ∞ | 0.50 | 1.52100 | 65.1 | |
| 2 | ∞ | (Variable) | | | |
| 3* | 222.663 | 10.00 | 1.76802 | 49.2 | 23.2 |
| 4* | −7.543 | 1.89 | | | 25.2 |
| 5* | −22.034 | 1.00 | 1.63540 | 23.9 | 20.6 |
| 6* | −95.300 | 2.57 | | | 23.7 |
| 7* | −6.296 | 2.78 | 1.53500 | 56.0 | 24.8 |
| 8* | −35.492 | 0.65 | | | 25.0 |
| 9* | 9.742 | 7.00 | 1.53500 | 56.0 | 24.2 |
| 10* | −21.380 | (Variable) | | | 24.0 |
| 11 | ∞ | 0.80 | 1.49171 | 57.4 | |
| 12 | ∞ | 23.00 | | | |
| 13 | (eye point) | | | | |

ASPHERIC DATA
3rd Surface
K = −5.36684e+04 A 4 = −4.89392e−05 A 6 = 5.73285e−07 A 8 = −3.81851e−09
A10 = 7.79489e−12
4th Surface
K = −3.51747e+00 A 4 = −6.94365e−05 A 6 = 8.24824e−08 A 8 = 2.82925e−11
A10 = −3.05228e−12
5th Surface
K = −3.59603e+01 A 4 = −2.01346e−04 A 6 = −2.91271e−06 A 8 = 2.17096e−08
A10 = −2.68354e−11
6th Surface
K = 4.05609e+01 A 2 = 4.15693e−02 A 4 = −5.03937e−04 A 6 = 2.70995e−06
A 8 = −7.12854e−09 A10 = 9.84489e−12
7th Surface
K = −7.65111e+00 A 4 = 2.74715e−04 A 6 = −1.13764e−06 A 8 = 1.18191e−09
A10 = 1.23324e−11 A12 = −5.87537e−14
8th Surface
K = −8.80935e+00 A 4 = −2.23285e−05 A 6 = −3.64339e−07 A 8 = 6.32929e−09
A10 = −3.26822e−11 A12 = 4.46417e−14
9th Surface
K = −1.30307e+01 A 4 = −8.98635e−05 A 6 = 1.60254e−06 A 8 = −1.71821e−08
A10 = 5.58828e−11
10th Surface
K = −1.21206e+01 A 4 = −1.48902e−04 A 6 = 1.85068e−06 A 8 = −1.39353e−08
A10 = 4.03491e−11
VARIOUS DATA

| | | | |
|---|---|---|---|
| Diopter (D) | −1.00 | −4.00 | +2.00 |
| Focal Length | 20.28 | 20.28 | 20.28 |
| Display Diagonal | 16.20 | 16.20 | 16.20 |
| Length (mm) | | | |
| Apparent field | 21.33 | 20.30 | 22.33 |
| of view (°) | | | |
| d2 | 6.73 | 5.38 | 7.95 |
| d10 | 2.09 | 3.38 | 0.70 |

TABLE 1

| | | INEQUALITY | | | | | | | | | |
|---|---|---|---|---|---|---|---|---|---|---|---|
| | | (1) | (2) | (3) | (4) | (5) | (6) | (7) | (8) | (9) | (10) |
| EXAMPLE | 1 | −0.120 | −0.550 | 3.777 | 1.293 | −0.093 | 0.136 | −7.774 | 1.284 | 0.399 | r6 0.541 |
| NUMERICAL | | | | | | | | | | | r7 0.751 |
| | 2 | −0.073 | −0.559 | 3.549 | 1.232 | −0.059 | 0.074 | −9.272 | 1.268 | 0.399 | r6 0.581 |
| | | | | | | | | | | | r7 0.640 |
| | 3 | −0.749 | −0.715 | 2.079 | 0.482 | −1.556 | 0.731 | −0.789 | 1.164 | 0.402 | r6 0.672 |
| | 4 | −0.325 | −0.826 | 2.555 | 0.859 | −0.378 | 0.231 | −3.821 | 1.192 | 0.398 | r7 0.713 |
| | 5 | −0.088 | −0.528 | 2.544 | 0.819 | −0.108 | 0.050 | −10.965 | 1.190 | 0.398 | r7 0.644 |
| | 6 | 0.140 | −0.633 | 3.789 | 1.597 | 0.088 | −0.146 | −33.599 | 1.286 | 0.399 | r6 0.539 |
| | | | | | | | | | | | r7 0.763 |
| | 7 | 0.108 | −1.221 | 3.617 | 1.720 | 0.063 | −0.112 | −16.153 | 1.273 | 0.399 | r6 0.531 |
| | | | | | | | | | | | r7 0.747 |
| | 8 | −0.017 | −0.201 | 3.795 | 1.408 | −0.012 | 0.017 | −12.613 | 1.279 | 0.399 | r6 0.567 |
| | | | | | | | | | | | r7 0.732 |
| | 9 | −0.018 | −1.134 | 3.691 | 1.560 | −0.012 | 0.018 | −10.455 | 1.278 | 0.399 | r6 0.534 |
| | | | | | | | | | | | r7 0.738 |
| | 10 | −0.917 | −0.374 | 3.669 | 0.669 | −1.371 | 3.064 | −1.431 | 1.277 | 0.399 | r6 0.625 |
| | | | | | | | | | | | r7 0.647 |

### Display Apparatus 1

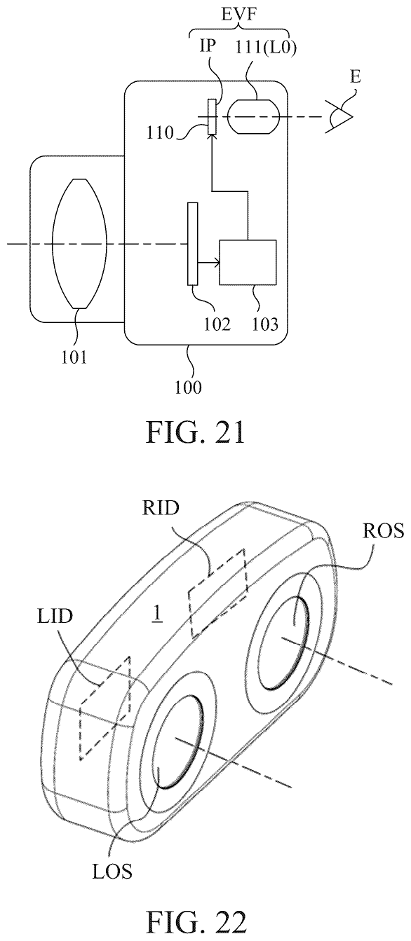

FIG. 21 illustrates the configuration of an image pickup apparatus (simply referred to as a camera hereinafter) 100 such as a digital camera or video camera having an electronic viewfinder EVF as a display apparatus including the display optical system L0 according to any one of Examples 1 to 10.

The camera 100 includes an imaging optical system 101, an image sensor 102 such as a CCD sensor or CMOS sensor configured to capture (photoelectrically converts) an object image (not illustrated) through the imaging optical system 101, and an image processing unit 103 configured to generate image data using a signal output from the image sensor 102.

The image data generated by the image processing unit 103 is output to a display element 110 of the electronic viewfinder EVF. The display element 110 displays an object image corresponding to the image data on its display surface IP.

The electronic viewfinder EVF includes an eyepiece optical system 111 that includes one of the display optical systems L according to Examples 1 to 10. A user (observer) of the camera 100 can enlarge and observe the subject image displayed on the display element 110 through the eyepiece optical system 111.

The display optical system L0 according to any one of Examples 1 to 10 as the eyepiece optical system 111 enables the user to observe a good object image with little image quality degradation due to a variety of aberrations such as lateral chromatic aberration and astigmatism.

### Display Apparatus 2

FIG. 22 illustrates a head-mounted display (HMD) as a display apparatus using the display optical system according to any one of Examples 1 to 10. The HMD is attached to the head (in front of the eyes) of the observer by a mounting gear (not illustrated).

The HMD includes right-eye and left-eye image display elements RID and LID, a right-eye display optical system ROS that guides display light from the right-eye image display element RID to the observer's right eye, and a left-eye display optical system LOS that guides display light from the left-eye image display element LID to the observer's left eye.

The display optical systems according to Examples 1 to 10 as the right-eye and left-eye display optical systems ROS and LOS can achieve a thin HMD with a wide angle of field.

Similarly, an optical see-through type HMD with a wide angle of field can be achieved by using the right-eye and left-eye image display elements and the display optical system illustrated in Example 3.

The display optical systems according to Examples 1 to 10 can also be used for a variety of display apparatuses other than electronic viewfinders and head-mounted displays.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example according to the disclosure can provide an optical system that has a reduced size, high magnification, and sufficient eye relief.

This application claims the benefit of Japanese Patent Application No. 2024-157960, which was filed on Sep. 12, 2024, and which is hereby incorporated by reference herein in its entirety.

What is claimed is:

1. An optical system configured to guide light from a display element to an observation side, the optical system comprising a plurality of lenses, the plurality of lenses consisting of, in order from a display element side to the observation side:
a first lens with positive refractive power;
a second lens with negative refractive power;
a third lens with refractive power; and
a fourth lens with refractive power,
wherein the following inequalities are satisfied:
$$- 10.00 < f 4 / f 3 < 0 \text{.15}$$
$$- 5. < ( R 41 + R 42 ) / ( R 41 - R 42 ) < - 0.19$$
$$0.5 < LD / L 1 < 40.0$$
where f3 is a focal length of the third lens, f4 is a focal length of the fourth lens, R41 is a radius of curvature of a display-element-side surface of the fourth lens, R42 is a radius of curvature of an observation-side surface of the fourth lens, L1 is an air-equivalent distance from a display surface of the display element to a display-element-side surface of the first lens in a case where diopter is −1 diopter, and LD is a distance on an optical axis from the display-element-side surface of the first lens to the observation-side surface of the fourth lens.

2. The optical system according to claim 1, wherein the following inequality is satisfied:
$$0.10 \leq f 4 / f \leq 5.$$
where f is a focal length of the optical system.

3. The optical system according to claim 1, wherein the following inequality is satisfied:
$$- 5. \leq f / f 3 \leq 0.50$$
where f is a focal length of the optical system.

4. The optical system according to claim 1, wherein the following inequality is satisfied:
$$- 2.00 \leq f 2 / f 3 \leq 5.$$
where f2 is a focal length of the second lens.

5. The optical system according to claim 1, wherein the following inequality is satisfied:
$$- 50.0 \leq ( R 32 + R 31 ) / ( R 32 - R 31 ) \leq - 0.1$$
where R31 is a radius of curvature of a display-element-side surface of the third lens, and R32 is a radius of curvature of an observation-side surface of the third lens.

6. The optical system according to claim 1, wherein the following inequality is satisfied:
$$0.8 \leq LD / f \leq 3.$$
where f is a focal length of the optical system.

7. The optical system according to claim 1, wherein the following inequality is satisfied:
$$0.3 \leq H / f \leq 0.50$$
where f is a focal length of the optical system, and H is a half diagonal length of the display surface of the display element.

8. The optical system according to claim 1, wherein at least one of the first lens to the fourth lens is an aspheric lens having an inflection point on at least one of a display-element-side surface and an observation-side surface.

9. The optical system according to claim 8, wherein the following inequality is satisfied:
$$0.3 \leq 2 \times He / φ \leq 0.8$$
where He is a height of the inflection point from the optical axis in the aspheric lens, and φ is an effective diameter of a surface having the inflection point on the aspheric lens.

10. The optical system according to claim 1, wherein the third lens has negative refractive power, and the fourth lens has positive refractive power.

11. The optical system according to claim 1, wherein the third lens has positive refractive power, and the fourth lens has positive refractive power.

12. A display apparatus comprising:
an optical system configured to guide light from a display element to an observation side; and
the display element;
wherein the optical system that includes a plurality of lenses, the plurality of lenses consisting of, in order from the display element side to the observation side:
a first lens with positive refractive power;
a second lens with negative refractive power;
a third lens with refractive power; and
a fourth lens with refractive power,
wherein the following inequalities are satisfied:
$$- 10. 00 < f 4 / f 3 < 0 \text{.15}$$
$$- 5. < ( R 41 + R 42 ) / ( R 41 - R 42 ) < - 0.19$$
$$0.5 < LD / L 1 < 40.0$$
where f3 is a focal length of the third lens, f4 is a focal length of the fourth lens, R41 is a radius of curvature of a display-element-side surface of the fourth lens, R42 is a radius of curvature of an observation-side surface of the fourth lens, L1 is an air-equivalent distance from a display surface of the display element to a display-element-side surface of the first lens in a case where diopter is −1 diopter, and LD is a distance on an optical axis from the display-element-side surface of the first lens to the observation-side surface of the fourth lens.

13. An image pickup apparatus comprising:
an image sensor; and
an electronic viewfinder that includes an optical system configured to guide light from a display element to an observation side; and
the display element;
wherein the optical system that includes a plurality of lenses, the plurality of lenses consisting of, in order from the display element side to the observation side:
a first lens with positive refractive power;
a second lens with negative refractive power;
a third lens with refractive power; and
a fourth lens with refractive power,
wherein the following inequalities are satisfied:
$$- 10. 00 < f 4 / f 3 < 0 \text{.15}$$
$$- 5. < ( R 41 + R 42 ) / ( R 41 - R 42 ) < - 0.19$$
$$0.5 < LD / L 1 < 40.0$$
where f3 is a focal length of the third lens, f4 is a focal length of the fourth lens, R41 is a radius of curvature of a display-element-side surface of the fourth lens, R42 is a radius of curvature of an observation-side surface of the fourth lens, L1 is an air-equivalent distance from a display surface of the display element to a display-element-side surface of the first lens in a case where diopter is −1 diopter, and LD is a distance on an optical axis from the display-element-side surface of the first lens to the observation-side surface of the fourth lens.
